(19) United States
(12) Patent Application Publication
(10) Pub. No.: US 2022/0374512 A1
(43) Pub. Date: Nov. 24, 2022

(54) SOFTWARE-BASED HARDWARE SECURITY MODULE (HSM) FOR A VIRTUALIZED COMPUTING ENVIRONMENT

(71) Applicant: VMware, Inc., Palo Alto, CA (US)

(72) Inventors: Radoslav GERGANOV, Sofia (BG); Vesselin ARNAUDOV, Sofia (BG)

(73) Assignee: VMware, Inc., Palo Alto, CA (US)

(21) Appl. No.: 17/326,344

(22) Filed: May 21, 2021

(51) Int. Cl. G06F 21/53; G06F 21/74; G06F 9/54; G06F 9/455

(52) U.S. Cl. CPC G06F 21/53; G06F 21/74; G06F 9/54; G06F 9/45558; G06F 2009/45587; G06F 2221/034

(57) ABSTRACT

A software-based implementation of a hardware security module (HSM) includes a software-based HSM device that uses a hardware-protected secure environment to provide protection for data and for execution of code of the HSM device. The HSM device operates in a virtualized computing environment, and an interface to the security device enables an application running on a virtualized computing instance to access the security device. The execution of the code in the secure environment is a first security mode of operation, and the HSM device can switch between multiple different security modes of operation.

### BACKGROUND

Unless otherwise indicated herein, the approaches described in this section are not admitted to be prior art by inclusion in this section.

Virtualization allows the abstraction and pooling of hardware resources to support virtual machines in a software-defined networking (SDN) environment, such as a software-defined data center (SDDC). For example, through server virtualization, virtualized computing instances such as virtual machines (VMs) running different operating systems (OSs) may be supported by the same physical machine (e.g., referred to as a host). Each virtual machine is generally provisioned with virtual resources to run an operating system and applications. The virtual resources may include central processing unit (CPU) resources, memory resources, storage resources, network resources, etc.

However, a virtualized computing environment having hosts that support VMs is often vulnerable to security threats, and so cryptographic techniques involving public/private keys are often used for security. A hardware security module (HSM) is one type of device that is used for such cryptographic techniques.

A HSM is a physical device that generates, protects, and manages digital keys for strong authentication, and may provide other functions (e.g., acceleration) that support cryptography. HSMs traditionally come in the form of a plug-in card or an external device that attaches directly to the host. HSMs are often used for their robust security properties—they provide an isolated hardware unit that performs secure cryptographic operations without exposing private keys to software on the system/host/network. HSMs can be used by public key infrastructure (PKI) services, key management services, financial payment applications, etc. in both public cloud environments and edge/Internet-Of-Things (IoT) environments, or other types of public/private environments.

While a dedicated hardware security solution such as HSMs may seem to offer robust solutions for a range of applications, there are several downsides to the use of such hardware-based solutions. For example, dedicated hardware solutions are often inflexible, lack interoperability, and can lead an organization to vendor lock-in (e.g., a user becomes dependent on a particular vendor for products and services, thereby making a switch to another vendor difficult or costly) . As another example, the use of dedicated hardware solutions complicates management in a cloud environment, such as in a software-defined datacenter (SDDC). For instance, VM migration and host maintenance become difficult to manage when applications demand dedicated hardware access. Still further, dedicated hardware requirements can add significant costs to security solutions.

### BRIEF DESCRIPTION OF DRAWINGS

FIG. 1 is a schematic diagram illustrating an example virtualized computing environment that can implement a software-based HSM in a hardware-protected secure environment;

FIGS. 2 and 3 are schematic diagrams illustrating some of the HSM and secure environment components in the virtualized computing environment of FIG. 1;

FIG. 4 is a schematic diagram illustrating interaction of an application with a secure environment for execution of code;

FIG. 5 is a flow diagram of an example interaction between an application, HSM components, and a secure enclave in the virtualized computing environment of FIG. 1;

FIGS. 6 and 7 are schematic diagrams respectively illustrating other security modes of operation that may be used in the virtualized computing environment of FIGS. 1; and

FIG. 8 is a flowchart of an example method to operate a software-based HSM device in the virtualized computing environment of FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. The aspects of the present disclosure, as generally described herein, and illustrated in the drawings, can be arranged, substituted, combined, and designed in a wide variety of different configurations, all of which are explicitly contemplated herein.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

The hardware-only implementation of the HSMs provides the advantages and disadvantages such as described above. An alternative to the hardware-only implementation of HSMs is a software-only implementation of HSMs that attempts to address some of the drawbacks of the hardware-only implementation of HSMs. An example of a software-only implementation of an HSM is the open source SoftHSM project. Such software-only implementations leverage software encryption and operating system isolation features to emulate hardware functionality. However, a problem with such software-only alternatives is that their security lacks robustness. For instance, while software-only solutions may offer flexibility and simplicity, such software-only solutions may be more vulnerable to attack by software processes running on the same system. For example, a compromised operating system (OS) may allow an attacker to extract private keys in the SoftHSM key store. As such, security guarantees in software-only solutions may be much weaker than their hardware counterparts.

The present disclosure addresses the above and other drawbacks of current hardware-only and software-only implementations of HSMs, by providing a software-based implementation of HSM that leverages the security protections provided by hardware, specifically secure enclaves provided by hardware. In this manner, the software-based HSM techniques disclosed herein receive the benefit of both worlds: the flexibility of software and the security robustness of hardware.

For example, the embodiments described herein combine a software-based implementation of HSM with trusted execution environment (TEE) technologies. TEE technologies allow applications to create an isolated resource environment into which code and data can be loaded and then executed in a protected manner, even from privileged system software (such as an operating system) running on the same platform. Embodiments of a TEE described herein enable an application to create protected memory regions, referred to as secure enclaves or other hardware-protected secure environment, through a hardware application program interface (API). HSM-related code and data stored and executed in a secure enclave are encrypted and protected from direct access attacks through hardware enforcement mechanisms built into the platform.

Accordingly, the embodiments described herein allow the security functionality of hardware security solutions (like HSM) to be effectively and securely implemented by hardware-protected software. A result is an embodiment of HSM that has the flexibility of software along with the stronger security protections of hardware.

### Computing Environment For Software-Based HSM

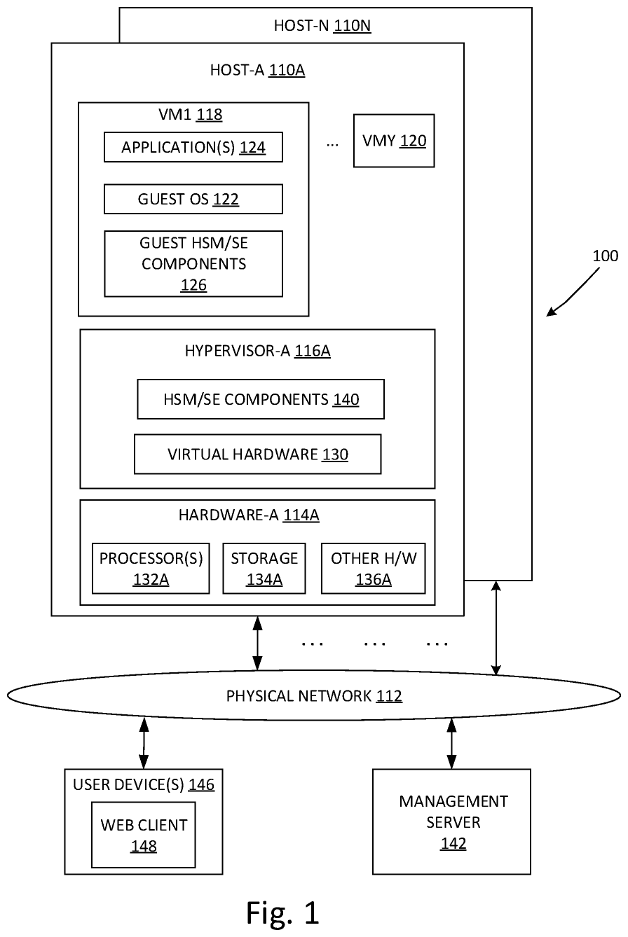

To further explain the operations of the elements that may cooperate to provide and support a software-based/software-defined HSM that is protected by hardware, various implementations will now be explained in more detail using FIG. 1, which is a schematic diagram illustrating an example virtualized computing environment 100 that can implement a software-based HSM in a hardware-protected secure environment. Depending on the desired implementation, virtualized computing environment 100 may include additional and/or alternative components than that shown in FIG. 1.

It is understood that the virtualized computing environment 100 is one example of a computing environment in which the methods described herein may be used. Methods to configure and use a hardware-protected software-based HSM may be implemented in other embodiments for other types of computing environments, including computing environments having physical endpoints (alternatively or in addition to endpoints that are comprised of virtualized computing instances) such as laptops, physical servers, mobile devices, desktop computers, etc. that are capable of using a software-based HSM.

In the example in FIG. 1, the virtualized computing environment 100 includes multiple hosts, such as host-A 110A ... host-N 110N that may be inter-connected via a physical network 112, such as represented in FIG. 1 by interconnecting arrows between the physical network 112 and host-A 110A ... host-N 110N. Examples of the physical network 112 can include a wired network, a wireless network, the Internet, or other network types and also combinations of different networks and network types. For simplicity of explanation, the various components and features of the hosts will be described hereinafter in the context of the host-A 110A. Each of the other host-N 110N can include substantially similar elements and features.

The host-A 110A includes suitable hardware 114A and virtualization software (e.g., a hypervisor-A 116A) to support various virtual machines (VMs). For example, the host-A 110A supports VM1 118 ... VMY 120, wherein Y (as well as N) is an integer greater than or equal to 1. In practice, the virtualized computing environment 100 may include any number of hosts (also known as computing devices, host computers, host devices, physical servers, server systems, physical machines, etc.), wherein each host may be supporting tens or hundreds of virtual machines. For the sake of simplicity, the details of only the single VM1 118 are shown and described herein.

VM1 118 may be a guest VM that includes a guest operating system (OS) 122 and one or more guest applications 124 (and their corresponding processes) that run on top of the guest OS 122. VM1 118 may further include one or more guest software-based HSM components, as well as components associated with establishing and operating a secure enclave (SE) or other hardware-protected secure environment, both of which are configured to cooperate to enable usage of the software-based HSM components in the secure environment in a manner that will be further described in detail later below. Such guest software-based HSM components (as well as the components associated with establishing and operating the secure environment) are collectively depicted in FIG. 1 as guest HSM/SE components 126.

The guest HSM/SE components 126 may include agents, services, applications (which may be one of the applications 124 and/or other applications), modules, engines, objects or other data, virtual/logical ports, drivers, application program interfaces (APIs), libraries, daemons, other software or code that is stored on a computer-readable medium and executable by a processor, etc., all of which are generally referred to herein as component(s) and represented and described herein in the context of the guest HSM/SE components 126. In some embodiments, one or more of the guest HSM/SE components 126 may be part of the guest OS 122 (e.g., reside in a user space and/or in a kernel space of the guest OS 122), while one or more of the guest HSM/SE components 126 may be separate from and external to the guest OS 122 (e.g., reside in VM1 118 outside of the guest OS 122) in some embodiments.

One or more of the guest OS 122, the guest application(s) 124, the guest HSM/SE components 126, and other code and related data (including data structures) associated with operating VM1 118 may be stored in a guest memory space that is provisioned for VM1 118 and/or in some other storage location in host-A 110A. For example, such guest memory may store a HSM library, a HSM driver, a trusted execution environment (TEE) application that generates and configures the secure environment, etc., whose operations will be described later below.

The hypervisor-A 116A may be a software layer or component that supports the execution of multiple virtualized computing instances. The hypervisor-A 116A may run on top of a host operating system (not shown) of the host-A 110A or may run directly on hardware 114A. The hypervisor 116A maintains a mapping between underlying hardware 114A and virtual resources (depicted as virtual hardware 130) allocated to VM1 118 and the other VMs.

In one embodiment, HSM/SE components 140 may run on top of or within the hypervisor-A 116A or elsewhere outside of the VMs. Analogous to the guest HSM/SE components 126 in VM1 118, these HSM/SE components 140 reside outside of VM1 118 and collectively represent one or more components associated with establishing and operating a hardware-protected secure environment and one or more software-based HSM components that use the secure environment, which will be further described in detail later below.

The HSM/SE components 140 may include agents, services, applications, modules, engines, objects or other data, virtual/logical ports, drivers, APIs, libraries, daemons, other software or code that is stored on a computer-readable medium and executable by a processor, devices and hardware, the secure environment/enclaves themselves or parts thereof, etc., all of which are generally referred to herein as component(s) and represented and described herein in the context of the HSM/SE components 140.

Hardware 114A includes suitable physical components, such as central processing unit(s) (CPU(s)) or processor(s) 132A; storage device(s) 134A; and other hardware 136A such as physical network interface controllers (NICs), storage disk(s) accessible via storage controller(s), etc. Virtual resources (e.g., the virtual hardware 130) are allocated to each virtual machine to support a guest operating system (OS) and application(s) in the virtual machine, such as the guest OS 122 and the application(s) 124 (e.g., a word processing application, accounting software, a browser, etc.) in VM1 118. Corresponding to the hardware 114A, the virtual hardware 130 may include a virtual CPU, a virtual memory (including the guest memory 138), a virtual disk, a virtual network interface controller (VNIC), etc.

A management server 142 of one embodiment can take the form of a physical computer with functionality to manage or otherwise control the operation of host-A 110A...host-N 110N. In some embodiments, the functionality of the management server 142 can be implemented in a virtual appliance, for example in the form of a single-purpose VM that may be run on one of the hosts in a cluster or on a host that is not in the cluster. The functionality of the management server 142 may be accessed via one or more user devices 146 that are operated by a system administrator. For example, the user device 146 may include a web client 148 (such as a browser-based application) that provides a user interface operable by the system administrator to access functionality of the management server 142.

The management server 142 may be communicatively coupled to host-A 110A ... host-N 110N (and hence communicatively coupled to the virtual machines, hypervisors, agents, drivers, applications and modules, hardware, etc.) via the physical network 112. The host-A 110A ... host-N 110N may in turn be configured as a data center that is managed by the management server 142. In some embodiments, the functionality of the management server 142 may be implemented in any of host-A 110A ... host-N 110N, instead of being provided as a separate standalone device such as depicted in FIG. 1.

Depending on various implementations, one or more of the physical network 112, the management server 142, and the user device(s) 146 can comprise parts of the virtualized computing environment 100, or one or more of these elements can be external to the virtualized computing environment 100 and configured to be communicatively coupled to the virtualized computing environment 100.

### Software-Based HSM In A Hardware-Protected Secure Environment

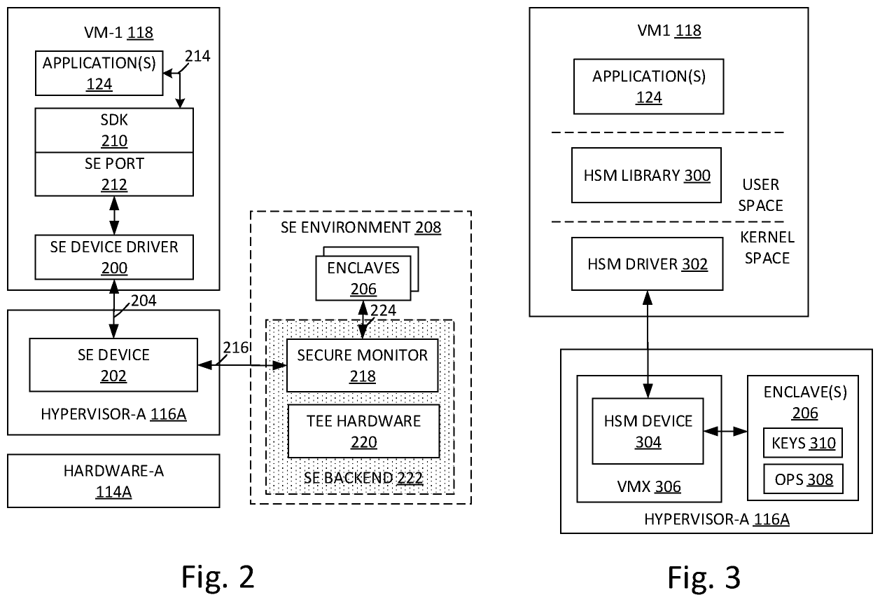

FIGS. 2 and 3 are schematic diagrams illustrating some of the HSM and secure environment components in the virtualized computing environment 100 of FIG. 1. More specifically, FIGS. 2 and 3 show further details of the guest HSM/SE components 126 of FIG. 1 that reside in VM1 118 and of the HSM/SE components 140 of FIG. 1 that reside outside of VM1 118 (such as in the hypervisor 116-A or elsewhere in the host-A 110A).

Referring first to FIG. 2, the guest HSM/SE components 126 includes a SE device driver 200 that is configured to communicate with a SE device 202 via an API 204. For example, the SE device 202 may be one of the HSM/SE components 140 that reside in or be provided by the hypervisor-A 116A, and may be a virtual device that is presented/exposed to VM1 118A via the API 204. Among other things, the SE device 202 provides an abstraction of low-level details of a trusted execution environment (TEE) including those of one or more secure enclaves (SE) 206 or other hardware-protected platform in a SE environment 208. The SE device 202 of various embodiments generates/configures and operates the enclaves 206 in the SE environment 208. Further in some embodiments, the SE device 202 (and/or some other device in the host-A 110A outside of VM1 118) contains software-based HSM functionality.

By being an abstraction and a virtual device that is exposed via the API 204, the SE device 202 may be accessed and used by applications 124, utilities, tools, etc. of VM1 118, such as for cryptographic or other security-related operations, via the SE device driver 200. For instance, the applications 124 may employ a software developer kit (SDK) 210 to facilitate interaction with the SE device driver 200 via a SE port 212 and an API 214. The SDK 210 and the SE port 212 may comprise parts of the guest HSM/SE components 126 shown in FIG. 1.

With respect to the HSM/SE components 140, the SE environment 208 is accessible to the SE device 202 via an API 216. According to some embodiments, the SE environment 208 (including the enclaves 206) may reside in the hypervisor-A 116A. In other embodiments, the SE environment may reside elsewhere in the host-A outside of the hypervisor-A 110A.

Depending on various implementations, the SE environment 208 includes a secure monitor 218 that is supported by TEE hardware 220 in a SE backend 222. The SE device 202 accesses the secure monitor 218 via the API 216, and the secure monitor 218 in turn passes commands/calls/data/etc. between the SE device 202 and the enclaves 206 via an API 224. In some embodiments, the SE backend 222 executes in the context of a user process and/or a kernel process of the hypervisor-A 116-A, while the SE backend 222 of still further embodiments may execute outside of or independently of any process of the hypervisor-A 110A.

Turning now to FIG. 3, FIG. 3 more specifically shows the HSM-related components of the guest HSM/SE components 126 and of the HSM/SE components 140 of FIG. 1. At VM1 118 according to some embodiments, a HSM library 300 resides or executes in the user space of the guest OS 122, and a HSM driver 302 resides or executes in the kernel space of the guest OS 122. Among other things, the HSM library 300 can store data, such as keys or other security-related objects/information, that are passed between the applications 124 and the enclaves 206 via an HSM device 304.

The HSM driver 302 may be the same as the SE device driver 200 shown and described above with respect to FIG. 2, or the HSM driver 302 may be some other driver in VM1 118. Analogously, the HSM device 304 residing in or provided by the hypervisor-A 116A may be the same as the SE device 202 described above with respect to FIG. 2, or the HSM device 304 may be some other device in host-A 110A outside of VM1 118. In some embodiments, the HSM device 304 is software-based, and the HSM device 304 may be exposed by a VMX file 306 of the hypervisor-A 116A for VM1 118.

The HSM device 304, as a software-based security device, executes at least some security-related operations inside of the secure enclave(s) 206. Such security-related operations may include, for example, cryptography operations involving private key generation, signing, authentication, password verification, etc. Accordingly, such security-related operations can be executed with added secrecy/isolation by virtue of the hardware-based protections provided by the enclaves 206.

In addition to execution of security-related operations inside of the enclaves 206, the enclaves 206 may also store keys 310, passwords, or other confidential information. As such, this confidential information also leverages the hardware-based security capability of the enclaves 206 for added protection.

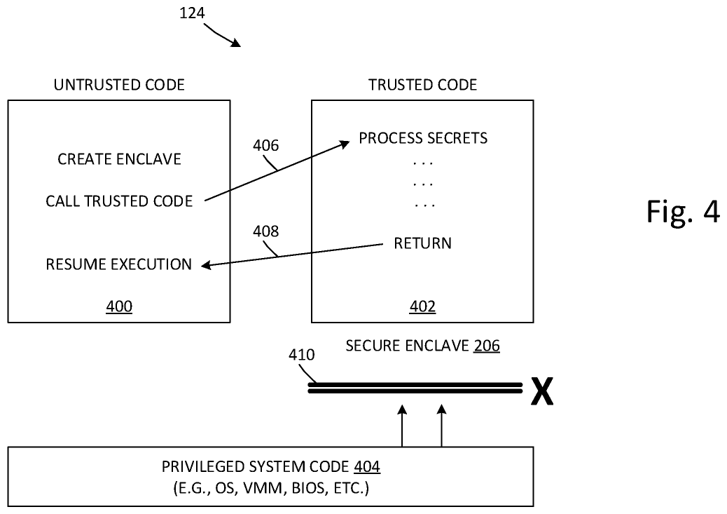

FIG. 4 is a schematic diagram illustrating interaction of an application with a secure environment for execution of code. For example, the application 124 may interact with the software (comprised of untrusted code 400 and trusted code 402) of the software-based HSM device 304. The untrusted code 400 may be code whose contents (including data) and execution processes are preferably protected by the functionality of the HSM device 304. However, it is possible that privileged system code 404 (such as the guest OS 122, virtual machine monitor (VMM) code, basic input/output system (BIOS) code, etc.) may get compromised by malicious code, thereby providing unauthorized access to the code 400 despite the level of protection provided by the HSM device 304 itself. Hence, such code 400 is considered to be untrusted code.

The trusted code 402 may be code whose contents (including data) and execution processes are preferably protected not only by the HSM device 304 but also by the enclave 206. The trusted code 402 may comprise code (and data), for example, that need a higher level of protection against unauthorized access. Hence, such code 402 is considered to be trusted code since they require a higher level of protection and are therefore resident and executed inside the enclave 206, so as to maintain the integrity/trustworthiness of such code.

As depicted in FIG. 4, the untrusted code 400 may include code to create the enclave 206 and code to call the trusted code 402. For instance during the course of executing a portion of the untrusted code 400, the execution sequence reaches a point in which a portion of trusted code needs to be called. Accordingly, the application 124 calls (shown at 406) into the enclave 206 in order to have that portion of the trusted code 402 executed inside of the enclave 206 (e.g., executing the portion of the trusted code to process secret information, etc.). When the execution of that portion of the trusted code is completed, the execution returns (shown at 408) to the untrusted code 400 outside of the enclave 206 to resume execution of subsequent portions of the untrusted code 400.

As symbolically depicted at 410 in FIG. 4, the privileged system code 404 does not have visibility or access into the enclave 206. Thus, the contents of the enclave 206 (e.g., keys, security-related code/operations and execution thereof, etc.) are protected against the privileged system code 404 in the event that such privileged system code 404 is compromised by a security threat.

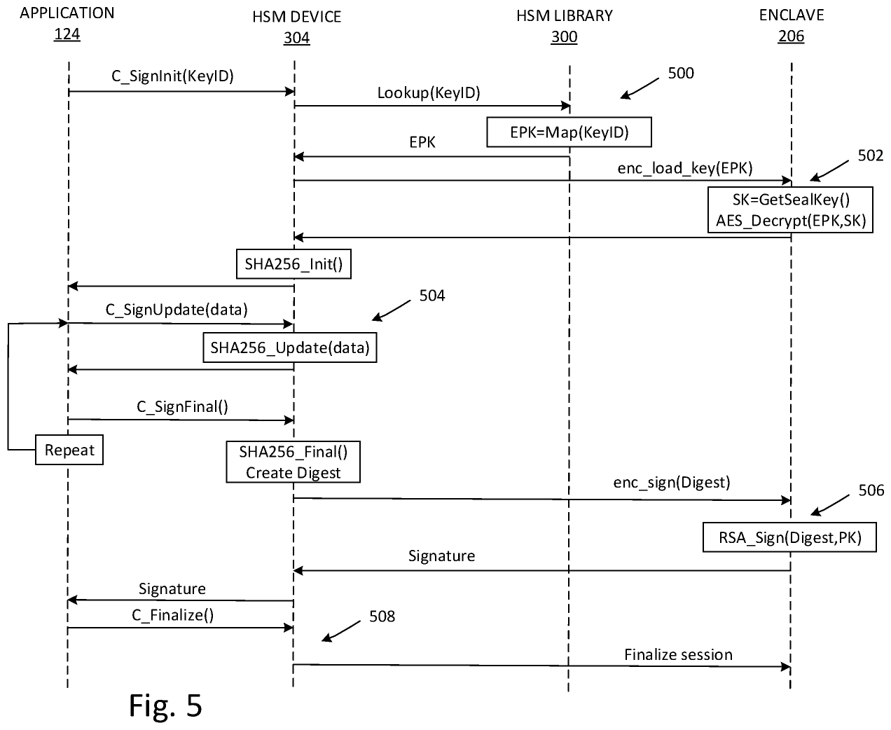

FIG. 5 is a flow diagram of an example interaction between an application, HSM components, and a secure enclave in the virtualized computing environment of FIG. 1. More specifically, FIG. 5 further illustrates the interaction(s) depicted in FIG. 4 and described previously above, in the context of encryption, decryption, signing, etc., wherein trusted code operations are performed/executed inside of the enclave 206 while untrusted code operations are performed/executed outside of the enclave 206.

Initially and not shown in FIG. 5, when the application 124 calls a key generation utility of the HSM device 304, the utility calls into the enclave 206, and the enclave 206 generates a key pair within the enclave 206. The enclave 206 returns both the public key and the private key, sealed by an enclave sealing key (SK) referred to as an encrypted private key (EPK) back to the HSM library 300 for storage and for use in later lookup.

Then later when the application 124 calls a utility of the HSM device 304 to perform a signing operation, the utility obtains the EPK from the HSM library 300, and passes the EPK back to the enclave 206. These operations are generally depicted at 500 in FIG. 5.

The EPK is decrypted inside of the enclave 206 (shown at 502 in FIG. 5). The decrypted EPK is subsequently passed from the enclave 206 back to the HSM device 304, so that operations can be performed to calculate a hash (e.g., generate a digest). The operations performed between the HSM device 304 and the application 124 to use the unencrypted private key to generate the digest are generally depicted at 504 in FIG. 5.

The HSM device 304 then sends the digest to the enclave 206, which then performs operations to sign the digest. The signing operation inside of the enclave 206 is shown generally at 506 in FIG. 5.

The enclave 206 sends the signature to the HSM device 304, which then sends the signature to the application 124. The session with the HSM device 304 and the enclave 206 is then finalized/ended. These operations are generally depicted at 508 in FIG. 5.

The foregoing description with respect to FIGS. 1-5 involve a first security mode of operation wherein at least some confidential/secret information and/or confidential/secret processes of the HSM device 304 are stored or executed inside of the hardware-protected enclave 206, for purposes of added security. According to some embodiments, capability is provided to enable the virtualized computing environment 100 (e.g., the HSM device 304) to switch between different security modes of operation.

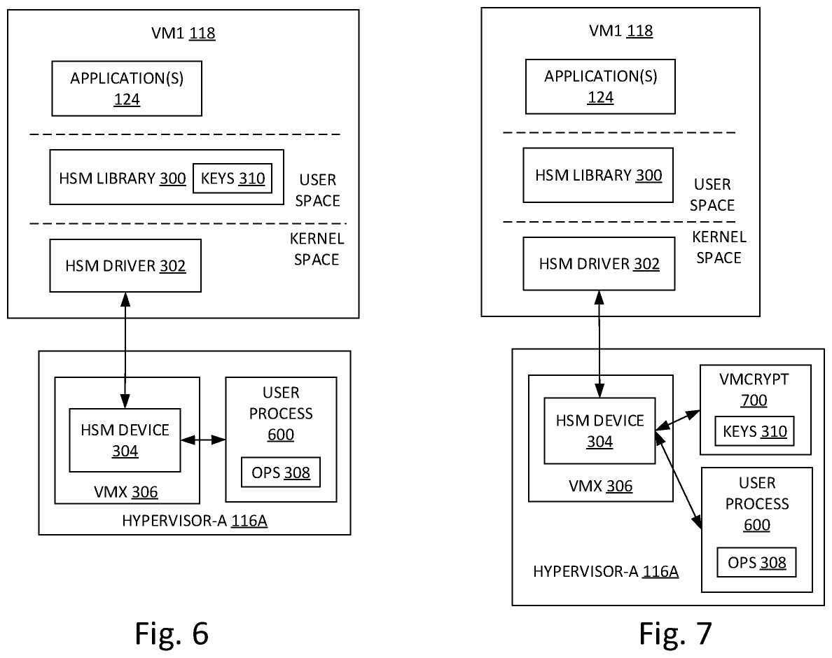

FIGS. 6 and 7 are schematic diagrams respectively illustrating other security modes of operation that may be used in the virtualized computing environment 100 of FIG. 1. Depending on configuration decisions made by a user (e.g., a system administrator operating the management server 142), the security mode of operation in the virtualized computing environment 100 can switch from one security mode of operation to another (different) security mode of operation. Such configuration decisions may be based on use cases, hardware resource availability, desired protection level, and/or other considerations.

FIG. 6 for a second security mode of operation (as well as FIG. 7 for a third security mode of operation) depicts some similar elements as FIG. 3 that depicts the first security mode of operation. Thus, similar elements between these figures are labeled using the same reference numbers.

Beginning with the second security mode of operation of FIG. 6, the keys 310 are stored in the HSM library 300 in the user space of the guest OS 122 of VM1 118, while the security-related operations 308 (e.g., cryptography operations) are performed in user processes 600 at the hypervisor-A 116-A. In this second security mode of operation, the protection level for the keys 310 may be classified as low, while the protection level for the security-related operations 308 may be classified as medium. Both of these protection levels may be relatively lower than those of the first security mode of operation wherein both the keys 310 and the security-related operations 308 have high protection levels by virtue of being located/executed in the enclave 206.

For the third security mode of operation of FIG. 7, a VM encryption utility (VMCrypt) 700 is used for encrypting VM1 118 and other VMs that run on the host-A 110A. The VM encryption utility 700 encrypts the keys 310 as well, while the security-related operations 308 are performed in the user processes 600 at the hypervisor-A 116-A. In this third security mode of operation, the protection level for the keys 310 may be classified as medium, while the protection level for the security-related operations 308 also may be classified as medium. Both of these protection levels may thus also be relatively lower than those of the first security mode of operation wherein both the keys 310 and the security-related operations 308 have high protection levels by virtue of being located/executed in the enclave 206.

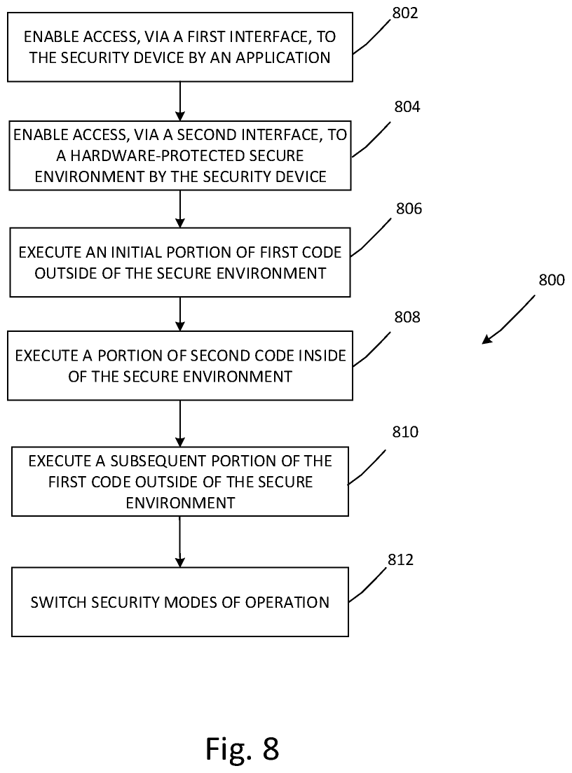

FIG. 8 is a flowchart of an example method 800 to operate a software-based HSM device in the virtualized computing environment 100 of FIG. 1. For example, the method 800 may be performed by the HSM device 304 or other similar software-based security device, in cooperation with the secure enclave(s) 206 (and/or some other hardware-protected secure environment), the application(s) 124, the HSM driver 302, the HSM library 300, etc., for purposes of executing untrusted (first) code outside of the enclave 206 and executing trusted (second) code in the enclave 206.

Example method 800 may include one or more operations, functions, or actions illustrated by one or more blocks, such as blocks 802 to 812. The various blocks of the method 800 and/or of any other process(es) described herein may be combined into fewer blocks, divided into additional blocks, supplemented with further blocks, and/or eliminated based upon the desired implementation. In one embodiment, the operations of the method 800 and/or of any other process(es) described herein may be performed in a pipelined sequential manner. In other embodiments, some operations may be performed out-of-order, in parallel, etc.

Beginning at a block 802 (“ENABLE ACCESS, VIA A FIRST INTERFACE, TO THE SECURITY DEVICE BY AN APPLICATION”), access to the HSM device 304 by the application 124 is enabled via the API 124 and the SE device driver 200.

At a block 804 (“ENABLE ACCESS, VIA A SECOND INTERFACE, TO A HARDWARE-PROTECTED SECURE ENVIRONMENT BY THE SECURITY DEVICE”), access by the HSM device 304 to the enclave 206 is enabled via the APIs 216 and 224, and also by the secure monitor 218.

The block 804 may be followed by a block 806 (“EXECUTE AN INITIAL PORTION OF FIRST CODE OUTSIDE OF THE SECURE ENVIRONMENT”). For example, the application 124 may send a first command to the HSM device 304 to perform encryption, decryption, signature, etc. operations. In response to the first command, the HSM device 304 may execute at least some of the untrusted code 400 shown in FIG. 4 outside of the enclave 206.

The block 806 may be followed by a block 808 (“EXECUTE A PORTION OF SECOND CODE INSIDE OF THE SECURE ENVIRONMENT”), wherein the HSM device sends a second command (such as a call depicted at 406 in FIG. 4) to the enclave 206 to execute at least some of the trusted code 402 inside of the enclave 206. When the execution of the portion of the trusted code 402 inside of the enclave 206 is completed, execution returns (shown at 408) to the untrusted code 400.

The block 808 may be followed by a block 810 (“EXECUTE A SUBSEQUENT PORTION OF THE FIRST CODE OUTSIDE OF THE SECURE ENVIRONMENT”), wherein a subsequent portion of the untrusted code 400 is executed outside of the enclave 206.

At a block 812 (“SWITCH SECURITY MODES OF OPERATION”), the security modes of operation may be switched for next processes. For example and as depicted in FIGS. 3, 6, and 7, the HSM device 304 may switch between the first, second and third security modes of operation depending on various use cases, hardware resources, desired protection levels, etc.

### Computing Device

The above examples can be implemented by hardware (including hardware logic circuitry), software or firmware or a combination thereof. The above examples may be implemented by any suitable computing device, computer system, etc. The computing device may include processor(s), memory unit(s) and physical NIC(s) that may communicate with each other via a communication bus, etc. The computing device may include a non-transitory computer-readable medium having stored thereon instructions or program code that, in response to execution by the processor, cause the processor to perform processes described herein with reference to FIGS. 1-8. For example, computing devices capable of acting as host devices may be deployed in virtualized computing environment 100.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

Although examples of the present disclosure refer to “virtual machines,” it should be understood that a virtual machine running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system; or implemented as an operating system level virtualization), virtual private servers, client computers, etc. The virtual machines may also be complete computation environments, containing virtual equivalents of the hardware and system software components of a physical computing system. Moreover, some embodiments may be implemented in other types of computing environments (which may not necessarily involve a virtualized computing environment), wherein it would be beneficial to provide hardware-based protected environments for the processes and data of software-based security tools.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood that each function and/or operation within such block diagrams, flowcharts, or examples can be implemented, individually and/or collectively, by a wide range of hardware, software, firmware, or any combination thereof.

Some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure.

Software and/or other instructions to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. The units in the device in the examples can be arranged in the device in the examples as described, or can be alternatively located in one or more devices different from that in the examples. The units in the examples described can be combined into one module or further divided into a plurality of sub-units.

We claim:

1. A method to operate a software-based security device in a virtualized computing environment, the method comprising:
enabling access, via a first interface, to the security device by an application of a virtualized computing instance supported by host in the virtualized computing environment;
enabling access, via a second interface, to a hardware-protected secure environment by the security device;
in response to a first command received by the security device from the application via the first interface, executing an initial portion of first code of the security device outside of the secure environment;
after completion of execution of the initial portion of the first code, sending a second command via the second interface to the secure environment to execute a portion of second code of the security device inside of the secure environment; and
after completion of execution of the portion of the second code inside of the secure environment, executing a subsequent portion of the first code outside of the secure environment.

2. The method of claim 1, wherein:
the execution of the portion of the second code inside of the secure environment corresponds to a first security mode of operation;
a second security mode of operation includes execution of the portion of the second code in a user process of a hypervisor of the host;
a third security mode of operation includes encryption of keys associated with the second code by an encryption utility that encrypts the virtualized computing instance; and
the security device is configurable to switch between the first, second, and third security modes of operation.

3. The method of claim 1, wherein the software-based security device is a software implementation of a hardware-based hardware security module (HSM).

4. The method of claim 1, wherein the first and second codes are associated with encryption, decryption, and signature operations of the security device.

5. The method of claim 1, wherein:
enabling access to the security device via the first interface includes presenting the security device as virtual device that is abstracted from a trusted execution environment (TEE) platform that provides the secure environment, and
the first interface includes an application program interface (API) and a driver that enable communication between the application and the security device.

6. The method of claim 1, wherein:
the security environment includes a backend portion having a secure monitor resident therein that is supported by trusted execution environment (TEE) hardware, and
enabling access to the secure environment via the second interface includes operating an application program interface (API) between the security device and the secure monitor resident at the backend portion.

7. The method of claim 1, wherein at least some components of the security device and the secure environment reside in a hypervisor of the host.

8. A non-transitory computer-readable medium having instructions stored thereon, which in response to execution by one or more processors, cause the one or more processors to perform operations of a software-based security device in a virtualized computing environment, the operations comprising:
enabling access, via a first interface, to the security device by an application of a virtualized computing instance supported by host in the virtualized computing environment;
enabling access, via a second interface, to a hardware-protected secure environment by the security device;
in response to a first command received by the security device from the application via the first interface, executing an initial portion of first code of the security device outside of the secure environment;
after completion of execution of the initial portion of the first code, sending a second command via the second interface to the secure environment to execute a portion of second code of the security device inside of the secure environment; and
after completion of execution of the portion of the second code inside of the secure environment, executing a subsequent portion of the first code outside of the secure environment.

9. The non-transitory computer-readable medium of claim 8, wherein:
the execution of the portion of the second code inside of the secure environment corresponds to a first security mode of operation;
a second security mode of operation includes execution of the portion of the second code in a user process of a hypervisor of the host;
a third security mode of operation includes encryption of keys associated with the second code by an encryption utility that encrypts the virtualized computing instance; and
the security device is configurable to switch between the first, second, and third security modes of operation.

10. The non-transitory computer-readable medium of claim 8, wherein the software-based security device is a software implementation of a hardware-based hardware security module (HSM).

11. The non-transitory computer-readable medium of claim 8, wherein the first and second codes are associated with encryption, decryption, and signature operations of the security device.

12. The non-transitory computer-readable medium of claim 8, wherein:
enabling access to the security device via the first interface includes presenting the security device as virtual device that is abstracted from a trusted execution environment (TEE) platform that provides the secure environment, and
the first interface includes an application program interface (API) and a driver that enable communication between the application and the security device.

13. The non-transitory computer-readable medium of claim 8, wherein:
the security environment includes a backend portion having a secure monitor resident therein that is supported by trusted execution environment (TEE) hardware, and
enabling access to the secure environment via the second interface includes operating an application program interface (API) between the security device and the secure monitor resident at the backend portion.

14. The non-transitory computer-readable medium of claim 8, wherein at least some components of the security device and the secure environment reside in a hypervisor of the host.

15. An apparatus configured to operate a software-based security device in a virtualized computing environment, the apparatus comprising:
a processor;
a non-transitory computer-readable medium coupled to the processor and having instructions stored thereon, which in response to execution by the processor, cause the processor to perform operations that include:
enable access, via a first interface, to the security device by an application of a virtualized computing instance supported by host in the virtualized computing environment;
enable access, via a second interface, to a hardware-protected secure environment by the security device;
in response to a first command received by the security device from the application via the first interface, execute an initial portion of first code of the security device outside of the secure environment;
after completion of execution of the initial portion of the first code, send a second command via the second interface to the secure environment to execute a portion of second code of the security device inside of the secure environment; and
after completion of execution of the portion of the second code inside of the secure environment, execute a subsequent portion of the first code outside of the secure environment.

16. The apparatus of claim 15, wherein:
the execution of the portion of the second code inside of the secure environment corresponds to a first security mode of operation;
a second security mode of operation includes execution of the portion of the second code in a user process of a hypervisor of the host;
a third security mode of operation includes encryption of keys associated with the second code by an encryption utility that encrypts the virtualized computing instance; and
the security device is configurable to switch between the first, second, and third security modes of operation.

17. The apparatus of claim 15, wherein the software-based security device is a software implementation of a hardware-based hardware security module (HSM).

18. The apparatus of claim 15, wherein the first and second codes are associated with encryption, decryption, and signature operations of the security device.

19. The apparatus of claim 15, wherein:
enabling access to the security device via the first interface includes presenting the security device as virtual device that is abstracted from a trusted execution environment (TEE) platform that provides the secure environment, and
the first interface includes an application program interface (API) and a driver that enable communication between the application and the security device.

20. The apparatus of claim 15, wherein:
the security environment includes a backend portion having a secure monitor resident therein that is supported by trusted execution environment (TEE) hardware, and
enabling access to the secure environment via the second interface includes operating an application program interface (API) between the security device and the secure monitor resident at the backend portion.

21. The apparatus of claim 15, wherein at least some components of the security device and the secure environment reside in a hypervisor of the host.
